(19) United States
(12) Patent Application Publication
(10) Pub. No.: US 2009/0001008 A1
(43) Pub. Date: Jan. 1, 2009

(54) End-Cap Device For High Efficiency Disposable Chromatography Column

(76) Inventors: Nandu Deorkar, Cedar Knolls, NJ (US); Paul A. Bouis, Bethlehem, PA (US)

Correspondence Address: Mallinckrodt Inc., 675 McDonnell Boulevard, HAZELWOOD, MO, 63042, US

(21) Appl. No.: 12/161,085

(22) PCT Filed: Jan. 4, 2007
(86) PCT No.: PCT/US07/00423

§ 371 Date: Jul. 16, 2008

Related U.S. Application Data
(60) Provisional application No. 60/763,670, filed on Jan. 31, 2006.

(51) Int. Cl. B01D 15/08

(52) U.S. Cl. 210/198.2

(57) ABSTRACT

A low cost re-usable end-cap for disposable chromatographic columns or solid phase extraction cartridges that simultaneously provide sealing of the column and axial compression, and chromatography columns and solid phase extraction cartridges employing such re-usable end caps.

### FIELD OF THE INVENTION

This invention pertains to a low cost re-usable end-cap for disposable chromatographic columns or solid phase extraction cartridges that simultaneously provide sealing of the column and axial compression. The latter eliminates any voids that might have formed in the column between the top of the media and the fluid distribution disk. The invention also relates to high efficiency disposable chromatography columns utilizing the end-caps. The end-cap device is “stand alone” and requires no modification of the syringe type column with which it is used. This allows its repeated use with low cost disposable columns, thus reducing its cost per use.

### BACKGROUND OF THE INVENTION

It is well known that, in order for a chromatographic column to provide good separation efficiency, it is important for the fluid distribution device at the inlet end of the chromatographic packing bed to be in close contact with said packing uniformly across its surface, thereby avoiding any void spaces. This can be achieved by providing some means of applying external axial pressure on the device supporting the fluid distribution disk. At the same time, it is readily apparent that it is important to insure a good seal between the sides of the distribution disk and the walls of the chromatographic column, so that the fluid carrying the substances to be separated or purified is forced down the column and does not leak around the distribution disk.

Many devices have been described that apply such axial pressure in columns that are packed by the end-user. Some of these devices rely solely on pressure applied by hand or manual positioning of the piston to insure good contact between the distribution disk and the top of the chromatographic media in combination with complex devices aimed at establishing a high pressure seal between the sides of the thus positioned distribution disk and the walls of the chromatographic column. Examples of such systems can be found in U.S. Pat. No. 4,797,209 and U.S. Pat. No. 5,324,426.

Other devices use long plungers carrying the inlet or outlet fluid distribution disk. This allows the use of a single column with various amounts of chromatographic packings but also requires the use of pistons almost as long as the column itself. These protrude out of the column when a fully packed column is prepared. Immobilization of the plungers at the desired location can be achieved in a variety of ways. For instance, some use a solid threaded shaft to position the fluid distribution disk and flexible tubing to feed the liquid mixture to be purified to the inlet of the column (U.S. Pat. No. 4,891,133. Alternatively, the fluid can be brought to the head of the column through an opening inside a threaded piston. Such piston can either have a female thread that can be positioned by rotating around a male thread on the outside of the column, as in U.S. Pat. No. 4,655,917 or a male thread on the piston and a female thread machined into some fitting attached to the top of the chromatographic column.

Also, some systems use pressure from a liquid or gas to achieve axial movement of the piston which allows one to maintain a constant pressure on the chromatographic packing bed should it expand or contract during chromatographic operations. Such systems which have been described in U.S. Pat. No. 4,597,866, and U.S. Pat. No. 5,021,162. This approach requires some rather complex hydraulic systems.

All the systems described so far require complex fittings and/or threading of the chromatographic column itself, the cost of which makes them unsuitable for single use disposable type applications. Also, the fluid distribution disk is always an integral part of the piston or plunger.

Other types of columns have been developed with the objective of reducing hardware costs. For instance, chromatographic media can be packed in plastic tubing, which limits their use to low pressure applications such as solid phase extraction. In some cases, an end cap is permanently sealed on top of the tube and is commercially available from Analogix, Inc. In another example, protrusions in the end cap “snap” over corresponding features on the column body, as described in U.S. Pat. No. 6,565,745. Although these approaches meet the low cost requirement for this application, it does not allow for multiple use of the column or end fitting, since the two are permanently attached, nor does it provide any axial packing of the media bed. In addition it lacks sealing mechanism at the top of the resin bed for operation at higher pressure or flow. A disposable system that does provide axial compression of the resin bed has been described in U.S. Pat. No. 4,439,593. However, that particular system requires that pressure be applied by the chromatographic instrument to hold the assembly together, achieve a leak-proof system and provide radial compression through the end cap. That configuration is intended primarily for use with automated instruments.

Other similar type devices and mechanisms are disclosed in the following patents: U.S. Pat. Nos. 3,440,864; 3,904,527; 4,283,280; 4,451,363; 4,758,346; 5,188,730; 5,227,059; and 5,879,634.

Disposable chromatographic columns or solid phase extraction (SPE) cartridges are often supplied in standard syringe bodies. The packing is contained into the body of the syringe by inserting a liquid distribution disk or “frit” at the top and bottom of the bed. Such packed syringes are available, for example, from J. T Baker under the trade name Bakerbond SPE or Bakerbond Speedisk or Bakerbond OneShot or from Waters Corporation under the trade names Oasis or Sep-Pak. Because of a variety of reasons partial drying of the bed, mechanical shock, vibrations etc., settling of particles can occur which lead to a voiding between the packing and the frits during storage or shipping.

There is, therefore, a need for a low cost device that improves the performance of disposable low pressure chromatographic columns and solid phase extraction cartridges.

### SUMMARY OF THE INVENTION

In accordance with this invention there is provided a low cost re-usable end-cap for disposable chromatographic columns or solid phase extraction cartridges that simultaneously provide sealing of the column and axial compression, and chromatography columns and solid phase extraction cartridges employing such re-usable end caps. When used herein after the term “chromatography column” is mean to be inclusive of both chromatography columns, per se, and solid phase extraction cartridges.

The low cost reusable end-cap of this invention intended for use with a disposable chromatography column body comprises a piston having an externally threaded upper portion, and a lower portion smaller in diameter than the upper portion for insertion into an inlet end of a chromatography column body. There is an annular recess on the lower portion of the piston with a sealing element located in the recess. A through-bore or conduit extends through the upper and lower potions of the piston for receiving and providing liquid to a fritted disk and chromatographic media in the chamber of the chromatography column body. Associated with the piston in the end-cap is a retainer having first and second ends with an opening extending from the first end to the second end of the retainer. The opening at the first end is sized to snugly slide over and engage the external wall of the chromatography column body. An annular shoulder or lip resides between the first and second ends of the retainer and abutting the opening at the first end of the retainer, said annular shoulder or lip being for receiving and supporting an annular flange extending from the inlet end of chromatography column body. The opening in the retainer having internal threads adjacent the opening at the second end of the retainer with the internal threads engaging the external threads of the piston whereby screwing the external threads of the piston into the internal threads of the retainer would force the lower portion of the piston and the annular sealing element against the fritted disk near the inlet to the chamber of the chromatography column body.

The disposable chromatography column of the invention with the re-usable end-cap is a chromatography column body having an external wall and a hollow chamber through the body from an inlet end to an outlet end of the body. A shoulder is adjacent the outlet end of the chromatography column body with a first fritted disk received on said shoulder. A flange extends radially outward from the inlet end of the chromatography column body. Chromatographic media fills at least a portion of the chamber of the chromatography column body. A second fritted disk sits on top of the chromatographic media furthest from the outlet end of the chromatography column body. The low cost reusable end-cap of this invention used with the disposable chromatography column body comprises a piston having an externally threaded upper portion, and a lower portion smaller in diameter than the upper portion and inserted into the inlet end of the chromatography column body. There is an annular recess on the lower portion of the piston with a sealing element located in the recess. A through-bore or conduit extends through the upper and lower potions of the piston for receiving and providing liquid to the second fritted disk and chromatographic media in the chamber of the chromatography column body. Associated with the piston in the end-cap is a retainer having first and second ends with an opening extending from the first end to the second end of the retainer. The opening at the first end is sized such that it snugly slides over and engages the external wall of the chromatography column body. An annular shoulder or lip resides between the first and second ends of the retainer and abutting the opening at the first end of the retainer, said annular shoulder or lip receiving and supporting the annular flange extending from the inlet end of chromatography column body. The opening in the retainer has internal threads adjacent the opening at the second end of the retainer with the internal threads engaging the external threads of the piston whereby screwing the external threads of the piston into the internal threads of the retainer forces the lower portion of the piston and the annular sealing element against the second fritted disk near the inlet to the chamber of the chromatography column body.

In a further embodiment of the invention the end-cap has a connector located in the through-bore or conduit in the upper portion of the piston with said connector being connectable to a supply tube to allow analyte fluid to flow from the supply tube through the connector, the through-bore and second fritted disk to the chromatography media in the chamber of the chromatography column body. Preferably the inner surface of the through-bore or conduit in the upper portion of the piston is internally threaded and the connector is preferably a male threaded connector, most preferably an externally threaded male connector, generally a Luer lock male connector.

The sealing element located in the recess on the lower portion of the piston is preferably an o-ring seal of any suitable material, such as for example Teflon.

### BRIEF DESCRIPTION OF DRAWINGS

The invention is illustrated by, but not limited to, the illustration shown in the drawing figures wherein:

FIG. 1 is an elevation view of a reusable end cap and chromatography column of this invention, and

FIG. 2 is a cross-sectional elevational view of the reusable end cap and chromatography column of FIG. 1.

### DETAILED DESCRIPTION OF THE INVENTION

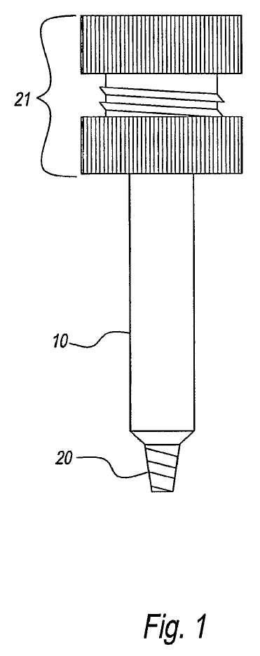

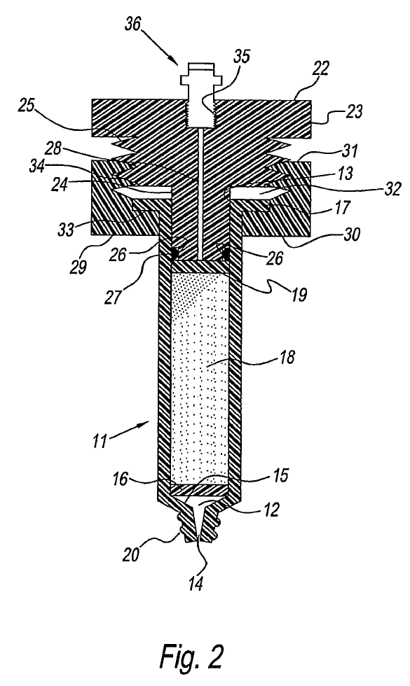

A preferred embodiment of the present invention is described in its assembled version in FIGS. 1 and 2. A chromatography column body or extraction cartridge can comprise a standard syringe body 10 formed by an external wall 11 and a hollow chamber 12 through the body from an inlet end 13 to an outlet end 14. A shoulder or lip 15 adjacent the outlet end 14 receives and holds a first fritted disk 16. At the inlet end 13 of the body 10 a flange 17 extends radially outward from the body 10. The chamber 12 is partially filled with a chromatographic media 18, with a second fritted disk 19 sitting on top of the chromatographic media slightly below the inlet end 13 of the body 10, i.e. generally in a location below the radially extending flange 17. On top of the chromatographic media 18 furthest away from the outlet end 14 of the body 10 is a second fritted disk 19 that acts as a distribution disk. The outlet end 14 of the syringe body 10 is fitted with some connecting device 20, such as a threaded male Luer lock conical connector.

A reusable end-cap 21 is employed on the chromatography column body 10. The end-cap 21 comprises a piston or plunger 22 having an upper portion 23 and a lower portion 24. The upper portion 23 has external threads 25 on at least part of the upper portion. The lower portion 24 is smaller in diameter or width than the diameter or width of the upper potion 23 for insertion into the inlet end 13 of chamber 12. The lower portion 24 of the piston 22 is provided, at the end of lower portion 24 inserted into chamber 12, with an annular recess 26 that receives a sealing element 27, generally an o-ring seal. A through-bore or conduit 28 extends through both the upper and lower portions 23 and 24 of piston 22. Through this bore or conduit 28 liquid to be analyzed or separated can be introduced to the chromatographic media 18 in the column body 1 through the second fritted disk 19. A retainer 29 has first and second ends 30 and 31 with an opening 32 extending from the first to the second ends. The opening 32 at the first end 30 is sized to snugly glide over and engage the external wall 11 of the chromatography column body 10. An annular shoulder 33 is provided between the first and second ends 30 and 31 of the retainer 29 abuts the opening 32 near the first end 30 of the retainer 29. This annular shoulder 33 receives and supports the annular flange 17 extending radially from the chromatography column body 10. The retainer 29 is provided with internal threads 34 adjacent the opening 32 at the second end 31 of retainer. The internal threads 34 engage external threads 25 on the upper portion 23 of piston 22 whereby turning the piston 22 screws the external threads of the piston into the internal threads of the retainer 29 forcing the lower portion 24 of the piston and the annular sealing element 27 into chamber 12 of the chromatography column body 10 and against the second fritted disk 19 forming a low pressure seal and forcing the fritted disk tightly against the chromatographic media 18 in the chamber. The annular seal 27 is preferably an annular O-ring placed in a circular recess 26 located at the tip of the lower portion 24 of piston 22 to provides the low pressure seal.

Through-bore or conduit 28, in the upper portion 23 of piston 22 can be provided with internal threads 35 for receiving a connecting device 36, such as a male threaded Luer lock connector, to permit liquid to be analyzed or separated to flow from a pump or gravity feeding reservoir (not shown) through a feeding tube (not shown) connected to the connector for supplying liquid to through-bore or conduit to the second fritted distribution disk 19 and into the chromatographic media 18.

The piston and retainer forming the end-cap of this invention provides a very simple mechanism for creating an axially compressed chromatography column without requiring a complex mechanism. With the device of this invention the piston is capable of going into the chamber of the chromatographic column body to exert pressure on the distribution frit to compress the bed of chromatographic media in the chamber of the column body and essentially eliminate undesirable voids in the chromatographic media during an analysis or separation procedure. The chromatographic column body need not have any threads on the column body. In accordance with this invention, the retainer member of the end-cap when inserted over and slid up the column body and the piston member is screwed into the retainer the end-cap form a seal itself with the seal member, e.g., O-ring, in the annual recess of the lower portion of the piston sealing against the inner wall of the column and the retainer member sealing externally against the annular flange member extending radially from the inlet end of the chromatographic column body.

The fact that the end-cap device forming the object of the present invention provides only a limited range of axial movement of the inlet tube is not an issue. Since the chromatographic column bodies are disposable, variable amount of media can be selected by choosing columns packed in standard syringes of different sizes. This being said, the used syringe cartridges can be emptied and repacked with fresh chromatographic media if desired.

The syringe barrel or tubes can be molded using high density polyethylene or polypropylene. For disposable column chromatographic applications high purity polypropylene is preferred. The syringe barrel can be any suitable size, such as for example, 0.5 cm to 10 cm internal diameter and 5 cm to 50 cm in length. The end-cap adapters of this invention can be made by any suitable means, such as for example, by machining by molding of suitable polymeric materials, such as for example, polyether ketone, high density polyethylene or polypropylene.

In another aspect, the said disposable chromatographic columns can be packed with chromatographic packing media with irregular or spherical particles with particle size from about 10 um to about 150 um and pore size of from 0 A (nonporous) to about 2000 A (highly porous). The chromatographic media can be based on any suitable material, such as for example, either inorganic oxides such as silica gels, controlled pore glass and titanium oxide or polymeric resins based materials such as polystyrene-divinylbenzene, poly-divinylbenzene, polymethacrylate, polyvinyl alcohol, or agarose. The packed columns can be used for separation of variety of analytes by normal phase, reverse phase, ion exchange or affinity mechanism using various used solvents, such as for example, water, methanol, ethanol, acetone, butanol, acids, hexane, ethyl acetate and mixtures thereof.

While the invention has been described herein with reference to the specific embodiments thereof, it will be appreciated that changes, modification and variations can be made without departing from the spirit and scope of the inventive concept disclosed herein. Accordingly, it is intended to embrace all such changes, modification and variations that fall with the spirit and scope of the appended claims.

We claim:

1. A disposable chromatography column comprising:
a chromatography column body having an external wall and a hollow chamber through the body from an inlet end to an outlet end of the body,
a shoulder adjacent the outlet end of the chromatography column body with a first fritted disk received on said shoulder,
a flange extending radially outward from the inlet end of the chromatography column body,
chromatographic media filling at least a portion of the chamber of the chromatography column body with a second fritted disk sitting on top of the chromatographic media furthest from the outlet end of the chromatography column body,
a piston having an externally threaded upper portion, a lower portion smaller in diameter than the upper portion inserted into the inlet end of the chromatography column body, an annular recess on the lower portion of the piston with a sealing element located in said recess,
a through-bore or conduit extending through the upper and lower potions of the piston for receiving and providing liquid to the second fritted disk and the chromatographic media in the chamber of the chromatography column body,
a retainer having first and second ends with an opening extending from the first end to the second end of the retainer, the opening at the first end sized to snugly slide over and engage the external wall of the chromatography column body, an annular shoulder between the first and second ends of the retainer and abutting the opening at the first end of the retainer, said annular shoulder receiving and supporting the annular flange extending from the chromatography column body, the opening having internal threads adjacent the opening at the second end of the retainer, said internal threads engaging the external threads of the piston whereby screwing the external threads of the piston into the internal threads of the retainer forces the lower portion of the piston and the annular sealing element against the second fritted disk in the chamber of the chromatography column body.

2. An end-cap for use with a disposable chromatography column body having an external wall and a hollow chamber through the body from an inlet end to an outlet end of the body with a flange extending radially outward from the inlet end of the chromatography column body, chromatographic media filling at least a portion of the chamber of the chromatography column body with a second fritted disk sitting on top of the chromatographic media furthest from the outlet end of the chromatography column body, the end-cap comprising:
a piston having an externally threaded upper portion, a lower portion smaller in diameter than the upper portion for insertion into the inlet end of the chromatography column body, an annular recess on the lower portion of the piston with a sealing element located in said recess,
a through-bore or conduit extending through the upper and lower potions of the piston for receiving and providing liquid to the second fritted disk and the chromatographic media in the chamber of the chromatography column body,
a retainer having first and second ends with an opening extending from the first end to the second end of the retainer, the opening at the first end sized to snugly slide over and engage the external wall of the chromatography column body, an annular shoulder between the first and second ends of the retainer and abutting the opening at the first end of the retainer, said annular shoulder for receiving and supporting the annular flange extending from the chromatography column body, the opening having internal threads adjacent the opening at the second end of the retainer, said internal threads engaging the external threads of the piston whereby screwing the external threads of the piston into the internal threads of the retainer would force the lower portion of the piston and the annular sealing element against the second fritted disk in the chamber of the chromatography column body.
